(19) United States
(12) Patent Application Publication
(10) Pub. No.: US 2024/0330662 A1
(43) Pub. Date: Oct. 3, 2024

(54) MULTIDIMENSIONAL SPACE DECOMPOSITION FOR TRANSFORMER NEURAL NETWORKS

(71) Applicant: QUALCOMM Incorporated, San Diego, CA (US)

(72) Inventors: Amir GHODRATI, Amsterdam (NL); Amirhossein HABIBIAN, Amsterdam (NL)

(21) Appl. No.: 18/193,234

(22) Filed: Mar. 30, 2023

(51) Int. Cl. G06N 3/0499

(52) U.S. Cl. CPC G06N 3/0499

(57) ABSTRACT

Certain aspects of the present disclosure provide techniques and apparatus for processing multidimensional content using neural networks. An example method generally includes decomposing a multidimensional input into a plurality of two-dimensional subspaces, wherein the plurality of two-dimensional subspaces share a common dimension. A first attention matrix is generated based on a projection of tokens in a first two-dimensional subspace of the plurality of two-dimensional subspaces via an attention block of a transformer neural network, and a second attention matrix is generated based on a projection of tokens in a second two-dimensional subspace of the plurality of two-dimensional subspaces via the attention block of the transformer neural network. An output of the transformer neural network is generated based on a combination of the first attention matrix and the second attention matrix.

### INTRODUCTION

Aspects of the present disclosure relate to neural networks, and more particularly, to processing multidimensional content using neural networks.

Various machine learning architectures have been used to provide solutions for a wide variety of computational problems. An assortment of machine learning model architectures exist, such as artificial neural networks (which may include convolutional neural networks (CNNs), recurrent neural networks (RNNs), deep neural networks, generative adversarial networks (GANs), and the like), random forest models, and the like. Increasingly, transformer neural networks have been widely used in a variety of image and video processing tasks, or other tasks in which multidimensional data is processed in order to generate various inferences related to the multidimensional data.

However, transformer neural networks tend to be computationally expensive. For example, because vision transformers generally compute self-attention at every block, the compute and memory demands may grow quadratically with respect to the size of the input data. While the computational complexity of these tasks may be addressed through the use of high performance processing units (e.g., graphics processing units, neural processing units, and/or other processing units that support high degrees of parallelism) and large amounts of memory, edge devices (e.g., user equipments (UEs), such as mobile devices or autonomous vehicles, etc.) may not have sufficient computing resources for processing multidimensional content (e.g., video content having two spatial dimensions (height and width) and a temporal dimension) at a sufficient performance level for the applications in which the processing is to be performed. For example, these edge devices may not have sufficient computing resources to satisfy real-time or near-real-time timing constraints for applications such as autonomous operations (e.g., self-driving cars, movement within constrained environments, etc.).

Accordingly, what is needed are improved techniques for efficiently processing multidimensional content using neural networks.

### BRIEF SUMMARY

Certain aspects provide a processor-implemented method for processing multidimensional content using neural networks. The method generally includes decomposing a multidimensional input into a plurality of two-dimensional subspaces, wherein the plurality of two-dimensional subspaces share a common dimension. A first attention matrix is generated based on a projection of tokens in a first two-dimensional subspace of the plurality of two-dimensional subspaces via an attention block of a transformer neural network, and a second attention matrix is generated based on a projection of tokens in a second two-dimensional subspace of the plurality of two-dimensional subspaces via the attention block of the transformer neural network. An output of the transformer neural network is generated based on a combination of the first attention matrix and the second attention matrix.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 illustrates an example transformer neural network architecture in which multidimensional data is processed.

FIG. 2 illustrates various pipelines for processing multidimensional data in transformer neural networks.

FIG. 3 illustrates example operations for processing multidimensional input through a transformer neural network based on decomposition of the multidimensional input into two-dimensional subspaces, according to aspects of the present disclosure.

FIG. 4 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for processing multidimensional inputs using transformer-based neural networks and decomposition of multidimensional inputs into multiple two-dimensional subspaces. As used herein, the term “multidimensional” generally refers to three or more dimensions (e.g., at least height, width, and time).

Various types of neural networks can be used to process visual content (e.g., detect objects, predict future motion of objects detected in visual content, segment visual content into different semantic groups, etc.), such as still images or streams of visual content (e.g., video content captured as a series of images at a given frame rate, such as 24 frames per second, 29.97 frames per second, 60 frames per second, etc.). However, these neural networks generally process visual content on a per-frame basis, which may be a computationally expensive process that increases in complexity as the frame size of each frame in the visual content increases.

Transformer neural networks (also referred to as “transformers”), and in particular vision transformers, have become increasingly common in a wide variety of machine learning tasks. Transformer-based architectures are generally configured to generate output based on a sequence of data (e.g., a sequence of frames in a video, a sequence of patches from a frame or image, and the like). Generally, machine learning models may use any number of transformer blocks (each providing self-attention), as well as any other components (e.g., one or more neural network layers).

For multidimensional data, such as video data having two spatial dimensions and a temporal dimension, processing using a transformer neural network may be computationally expensive due to the amount of data to be processed. This complexity may increase significantly as the amount of data to be processed increases; for example, in video content, the amount of data to be processed may scale quadratically in the spatial dimensions and the time dimension. Due to the structure of transformer blocks in a transformer neural network, the computational cost involved in processing inputs within any given transformer block may scale quadratically with the size of the input; for example, a doubling of resolution for a video input, while holding the duration of the video input constant, may result in a sixteen-fold increase in the computational expense of processing this video input through a transformer neural network. Further, because a transformer neural network may include multiple transformer blocks, each transformer may perform computations on input data independently, incurring significant computational cost.

Aspects of the present disclosure provide techniques for reducing the computational cost of processing multidimensional input data in transformer neural networks. As discussed in further detail herein, to reduce the computational complexity of processing a multidimensional input, aspects of the present disclosure decompose a multidimensional input into multiple two-dimensional subspaces which may share a common dimension; for example, in a video input having height, width, and temporal dimensions, the two-dimensional subspaces may be a height-time subspace and a width-time subspace. By decomposing a multidimensional input into multiple two-dimensional spaces sharing a common dimension, the computational expense involved in processing a multidimensional input in a transformer neural network may be reduced and may scale sub-quadratically. Thus, fewer compute resources may be utilized to complete various tasks for which transformer neural networks are used, such as object detection or other computer vision tasks. In turn, this may reduce the amount of power used by computing devices to perform these tasks and/or accelerate processing of multidimensional inputs, relative to the amount of power and/or time used when a multidimensional input is not decomposed into multiple two-dimensional spaces for processing.

### Example Transformer Architecture

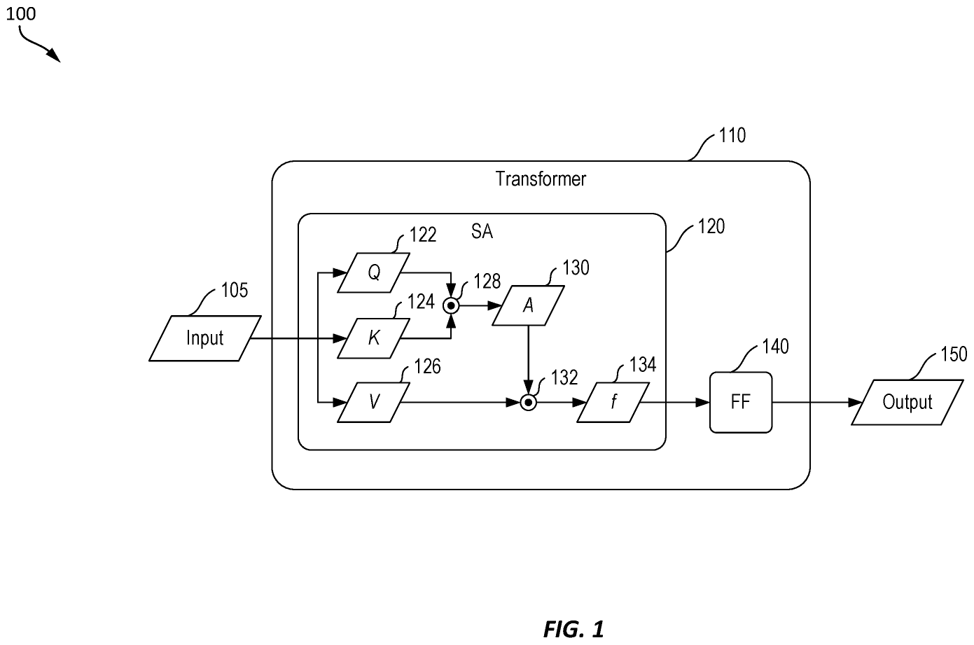

FIG. 1 illustrates an example transformer architecture 100 in which attention data is propagated through a transformer block in a neural network (e.g., for other transformer block(s) in the network) in order to generate an output of the neural network.

As illustrated in FIG. 1, input data 105 is accessed by a transformer 110. As used herein, accessing data can generally include receiving, retrieving, requesting, or otherwise gaining access to the data. As discussed above, the input data 105 may correspond to the input (e.g., raw or preprocessed input data) to the first transformer block of a model, the output of a prior transformer or other model component or block, and the like. For example, the input data 105 may correspond to a multidimensional input, a tokenized version of the multidimensional input (which may optionally include positional embedding(s) and/or learnable token(s)), or the like. The tokenized version of the multidimensional input may also be referred to as a set of features for the multidimensional input generated over different portions of the multidimensional input (e.g., different spatial portions, or patches, of the multidimensional input across multiple points in time).

Generally, transformer 110 includes a self-attention block 120 (labeled “SA”) and a feedforward block 140 (labeled “FF”). In self-attention block 120, input data 105 may be linearly projected (e.g., multiplied using learned parameters) into three matrices: a query matrix Q 122 (also referred to in some aspects as a “query representation” or simply “queries”), a key matrix K 124 (also referred to in some aspects as a “key representation” or simply “keys”), and a value matrix V 126 (also referred to in some aspects as a “value representation” or simply “values”). For example, during training, one or more query weights, key weights, and value weights are learned based on training data, and the queries Q 122, keys K 124, and values V 126 can be generated by multiplying the input data by the learned weights.

In some aspects, an attention matrix A 130 (also referred to as an “attention map” or simply “attention” in some aspects) is then generated based on the queries and keys. For example, the self-attention block may, at operation 128, compute the dot product of the query matrix and the transposed key matrix (e.g., Q·K^{T}). In some aspects, the self-attention block can apply one or more operations (e.g., a row-wise softmax operation) to the dot product to yield that attention matrix. That is, the attention matrix A 130 may be defined as A=σ(Q·K^{T}), where σ is the softmax function (or some other regularizing function usable in a transformer neural network).

The resulting features f 134 generated by the self-attention block can then be computed, at operation 132, as the dot product of the attention matrix A 130 and the value matrix V 126. These features can then be provided as input to the feedforward block 140 (e.g., a neural network or subnet) to generate an output 150 from the transformer 110. The output 150 may be used as an input into a subsequent transformer or other block in a neural network or may be the final result of processing an input through the neural network. Feedforward block 140, in some aspects, may be a multilayer perceptron (MLP) including a plurality of layers separated by an activation function, such as a Gaussian error linear unit activation function.

Although not depicted in FIG. 1, in some aspects, transformer 110 may include one or more skip or residual connections (with or without layer normalization). For example, output 150 may be generated by summing the output of operation 132 with input data 105, skipping feedforward block 140. As another example, output 150 of the transformer 110 may be generated by summing the output of the final layer of the feedforward block 140 with the previous version of the output 150.

### Example Subspace Decomposition of Multidimensional Inputs for Processing in Transformer Neural Networks

As discussed, transformer neural networks can be used to process multidimensional inputs and generate inferences based on processing these multidimensional inputs. For example, these transformer neural networks can be used in performing various operations on video data, such as video enhancement (e.g., noise reduction, upsizing via super resolution techniques that increase or otherwise enhance the resolution of an input), object detection, three-dimensional vision, medical imaging, or the like. In object detection tasks, for example, the outputs generated by transformer neural networks can be used to semantically segment an input into different segments associated with different levels of importance to the overall meaning of the scene and select different portions of the scene for monitoring (e.g., corresponding to different objects). The outputs generated by transformer neural networks can also be used, for example, to predict the motion of objects in a scene, which then can be used to apply various control inputs to an autonomous or semi-autonomous vehicle to ensure that the vehicle does not collide with these objects (or at least reduce the likelihood that the vehicle will collide with these objects). In the three-dimensional vision example, transformer neural networks can be used to recreate environments in the three-dimensional space based on truncated signed distance function (TSDF) data or the like. In the medical imaging example, transformer neural networks can be used for segmentation of three-dimensional data to identify various structures in captured medical imaging, such as blood vessels, tumors, and the like.

In many of these use cases, information captured over time may be useful data that can be used in generating various inferences from multidimensional inputs. For example, in computer vision tasks, motion information captured over time may be highly useful data for processing video content. Because of the nature of transformer neural networks, temporal dependencies (or relationships) between different portions of a multidimensional input (e.g., different frames of video having different timestamps) can be used, for example, to identify objects in motion, stationary objects, spatial relationships between different objects in a frame, and the like. However, as discussed above, processing multidimensional inputs using transformer neural networks may be a computationally expensive task. In a transformer neural network, each token of an input-corresponding, for example, to different discrete portions of the input, such as patches in an image (e.g., a pixel or a contiguous block of pixels in an image)—may be compared with other tokens generated for the input. Because of these comparisons, the computational complexity involved in processing multidimensional inputs using a transformer neural network may scale quadratically with input resolution and with time (or time resolution, such as a frame rate at which video frames are captured). Thus, while some devices may be capable of processing multidimensional inputs using transformer neural networks, it may not be practical to deploy transformer neural networks for processing these multidimensional inputs on other devices (e.g., user equipments (UEs) in a wireless communications network, internet-of-things (IoT) devices, or other power-constrained devices which may have limited compute capabilities or compute capabilities constrained by the amount of power that can be drawn from an energy storage device.

To improve the efficiency of transformer neural networks and reduce the computational complexity involved in processing inputs using transformer neural networks, various techniques can be used. In some examples, attention may be computed over a subset of tokens (instead of the entire set of tokens generated for an input) to achieve sub-quadratic compute complexity scaling for inputs into the neural network. This may be performed, for example, based on sparsity constraints, block-wise processing, axial processing, linear decomposition of multidimensional inputs into a one-dimensional input, other decompositions, or the like. In one example, space and time may be decomposed independently in order to reduce the computational complexity of processing a video input in a transformer neural network. In this example, the cost of the decomposition may be relatively small for low-resolution inputs; however, the computational complexity of processing an input may still be high for high-resolution inputs. In decomposing space and time separately, however, temporal information may not be accessible during processing of spatial content despite such temporal information including significant amounts of useful contextual data for processing video data and performing various actions with respect to an output of processing the video data through a transformer neural network.

To further reduce the computational complexity of processing video data or other multidimensional data through a transformer neural network, aspects of the present disclosure decompose multidimensional data (e.g., having three or more dimensions) into multiple two-dimensional subspaces sharing a common dimension. For example, video data having two spatial dimensions (height and width) and a temporal dimension can be decomposed into two, two-dimensional subspaces: a first subspace with width and time dimensions and a second subspace with height and time dimensions, where time is the common dimension. By decomposing multidimensional data into multiple two-dimensional subspaces sharing a common dimension, the computational complexity of processing such data may be distributed evenly, and the two-dimensional subspaces sharing a common dimension can both have access to significant amounts of useful contextual data in self-attention or other operations within the transformer neural network. In doing so, aspects of the present disclosure provide for computationally efficient processing of multidimensional data, with efficiencies relative to other decomposition techniques (e.g., as discussed in further detail below) increasing as input resolution increases. Further, aspects of the present disclosure may provide for similar inference accuracy (e.g., a peak signal-to-noise ratio (PSNR)) using fewer compute resources than space-time decomposition, may provide for increased inference accuracy using similar compute resources as other decomposition techniques, and may be computationally cheaper as the number of samples (e.g., frames in video content) used in a task increases relative to other decomposition techniques.

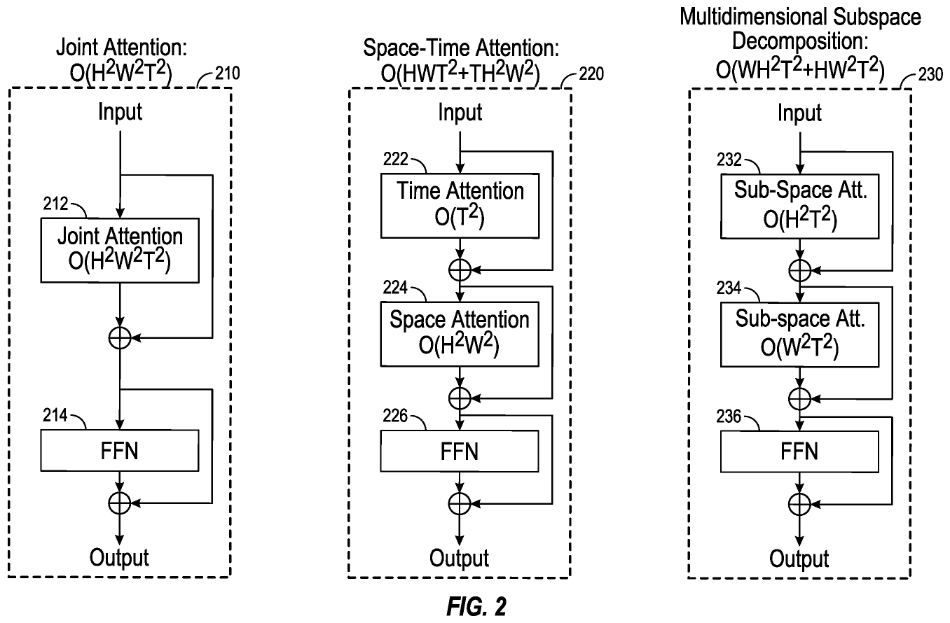

FIG. 2 illustrates pipelines for processing multidimensional data in transformer neural networks. While the pipelines in FIG. 2 illustrate transformer pipelines in the context of processing video data having height, width, and temporal dimensions, it should be recognized that the transformer pipelines illustrated in FIG. 2 may be applicable to processing n-dimensional data (with the addition or removal of attention heads in the pipeline). Further, while the pipelines illustrated in FIG. 2 illustrate various sequential operations for processing multidimensional data in transformer neural networks, it should be recognized that various operations illustrated in these pipelines may be performed in parallel, or substantially in parallel.

Pipeline 210 illustrates a pipeline for processing multidimensional data without decomposition of a multidimensional input into different subspaces. As illustrated, the multidimensional input may be processed through an attention head 212 of a transformer neural network (e.g., self-attention block 120 illustrated in FIG. 1). The output of the attention head 212 (in combination with the input) of the transformer neural network can be processed through a feed-forward network 214. The output of the feed-forward network 214 and the sum of the output of attention head 212 and the input may be combined to generate an output of the transformer neural network. Because the multidimensional data is not decomposed into smaller portions, there may be H*W*T tokens generated for the multidimensional input, where H and W correspond to a number of patches in the height domain and a number of patches in the width domain, respectively, into which the input is divided, and each token may be compared with all the other tokens generated for the multidimensional input. Thus, pipeline 210 can complete processing of the multidimensional input in O(H²W²T²) time.

Pipeline 220 illustrates a pipeline for processing multidimensional data with space-time decomposition of a multidimensional input including spatial and temporal components. In this example, the temporal component of a multidimensional input may be processed through a first attention head 222 of a transformer neural network, and the spatial component(s) of the multidimensional input may be processed through a second attention head 224 of the transformer neural network. As illustrated, the input into the second attention head 224 of the transformer neural network may be the sum of the output of the first attention head 222 and the input. The sum of the output of the first attention head, the input, and the second attention head output of the second attention head 224 may subsequently be processed through a feed-forward network 226. The output of the feed-forward network 226 and the sum of the output of the first attention head, the input, and the second attention head output of the second attention head 224 may be combined to generate an output of the transformer neural network. The computational complexity of processing the temporal component of the multidimensional input may be O(T²), and the computational complexity of processing the spatial component of the multidimensional input may be O(H²W²). Because the computational complexities involved in processing the temporal and spatial components of the multidimensional input are independent of each other (and thus are additive, not multiplicative), pipeline 220 can complete processing of the multidimensional input in O(HWT²+H²W²T) time, which represents a significant decrease in the computational complexity of processing a multidimensional input relative to the complexity of pipeline 210 discussed above.

However, as discussed above, further improvements in both the computational complexity and the accuracy of processing multidimensional inputs in a transformer neural network can be achieved by decomposing a multidimensional input into multiple two-dimensional subspaces sharing a common dimension. Pipeline 230 illustrates a pipeline for processing multidimensional data based on decomposing a multidimensional input into multiple two-dimensional subspaces sharing a common dimension, according to aspects of the present disclosure. In this example, a multidimensional input may have a height, a width, and a temporal component. Thus, a decomposition of this multidimensional input into a plurality of two-dimensional subspaces may be achieved by decomposing the multidimensional input into a first two-dimensional subspace including the height and temporal dimensions and a second two-dimensional subspace including the width and temporal dimensions.

As illustrated, a first attention head 232 can generate a first attention matrix based on a projection of the data in the first two-dimensional subspace (e.g., tokens generated for individual elements in the first two-dimensional subspace). A second attention head 234 can similarly generate a second attention matrix based on a projection of the data in the second two-dimensional subspace. The outputs of the first attention head 232 and the second attention head 234 can be combined (e.g., via a summation operation) with the input and provided as an input to a feed-forward network 236.

The computational complexity of processing the data in the first two-dimensional subspace via first attention head 232 may be O(H²T²). Similarly, the computational complexity of processing the data in the second two-dimensional subspace via second attention head 234 may be O(W²T²). As with pipeline 220, because processing data in attention heads 232 and 234 involves independent operations, the total computational complexity is additive and not multiplicative. Thus, pipeline 230 may complete processing of the multidimensional input in O(WH²T²+HW²T²) time, which may provide further improvements in the computational complexity of processing multidimensional data (having three or more dimensions) in a transformer neural network. Further, unlike in pipeline 220, the attention heads 232 and 234 in pipeline 230 process data having a shared dimension, which allows for useful contextual information (e.g., in the time domain) to be used in generating the attention matrices for both subspaces rather than discarding such information in one of the attention heads, which in turn may allow for reduced computational complexity in various tasks that involve multidimensional data (video enhancement (e.g., denoising, super resolution, etc.), video classification, semantic segmentation, object detection, three-dimensional reconstruction, anatomical segmentation, etc.) by allowing for a small number of consecutive samples (e.g., frames) to be used in order to perform various tasks. While FIG. 2 illustrates that the height-time subspace is processed prior to the width-time subspace, it should be recognized that the data in different subspaces can be processed in any order sequentially (e.g., such that the attention heads 232 and 234 are swapped in order) or may be processed in parallel or substantially in parallel.

As noted above, pipeline 230 can be used in processing data in any multidimensional space by decomposing the data into a plurality of two-dimensional subspaces sharing a common dimension. For example, a four-dimensional (e.g., three spatial and one temporal dimension) input can be decomposed into three two-dimensional subspaces sharing the time dimension as the common dimension, and the resulting transformer neural network through which the four-dimensional input is processed may include three attention heads (e.g., one for each two-dimensional subspace). Examples of data in a multidimensional space may include, for example, an audiovisual input including spatial, frequency, and time dimensions; an input including different spatial environments in which operations are performed along a common time dimension (e.g., an input in a virtual reality environment in which each spatial environment corresponds to data displayed on one of a plurality of time-synchronized displays); and the like.

While the foregoing examples illustrate time as a common dimension shared by the plurality of two-dimensional subspaces, it should be recognized that any other suitable dimension (e.g., frequency) may also or alternatively be used as the common dimension shared by the plurality of two-dimensional subspaces.

For an input of T samples in a D-dimensional space decomposed into a plurality of two-dimensional subspaces sharing a common dimension, a transformer neural network can complete processing the input in O(D×S^{D+1}T²) time, in contrast to O(TS^{2D}+S^{D}T²) time using space-time decomposition (e.g., as in pipeline 220 discussed above) or O(S^{2D}T²) time without decomposition. As discussed, the processing of multidimensional data based on decomposition of such data into a plurality of two-dimensional subspaces sharing a common dimension may be significantly less computationally expensive than processing multidimensional data using space-time decomposition, as the processing of data in multidimensional subspaces may reduce the amount of redundant data processed within a transformer neural network. These efficiencies may be seen in relation to the computational expense incurred in processing data, as it may be possible to generate usable inferences from multidimensional data using a smaller number of samples (e.g., frames in an input video segment) relative to other decomposition techniques. Further, it can be seen that significant decreases in computational expense may be achieved by processing fewer samples using a transformer neural network.

The reduction in computational complexity achieved by decomposition of multidimensional data into a plurality of two-dimensional subspaces sharing a common dimension relative to processing multidimensional data without decomposition (joint attention) may be represented by the expression:

$$O ( \frac{{S}^{D - 1}}{D} )$$

where S represents the size of a non-temporal dimension in the multidimensional space and D represents the number of spatial dimensions in the multidimensional space.

The reduction in computational complexity achieved by decomposition of multidimensional data into a plurality of two-dimensional subspaces sharing a common dimension relative to space-time decomposition of multidimensional data may be represented by the expression:

$$O ( \frac{{S}^{D} + T}{S \times D \times T} )$$

where T represents the number of samples in the multidimensional data.

The reduction in computational cost may scale based on the number of spatial dimensions included in the multidimensional input. For example, for a sequence of two-dimensional images, the computational complexity involved in processing this sequence through a transformer neural network may be reduced by

$$O ( \frac{S}{2 T} )$$

time relative to joint attention and may be reduced by

$$O ( \frac{{S}^{2} T}{2 ST} )$$

time relative to space-time decomposition. For a sequence of three-dimensional volumetric data, the computational complexity involved in processing this data through a transformer neural network may be reduced by

$$O ( \frac{{S}^{2}}{3 T} )$$

time relative to joint attention and may be reduced by

$$O ( \frac{{S}^{3} T}{3 ST} )$$

time relative to space-time decomposition.

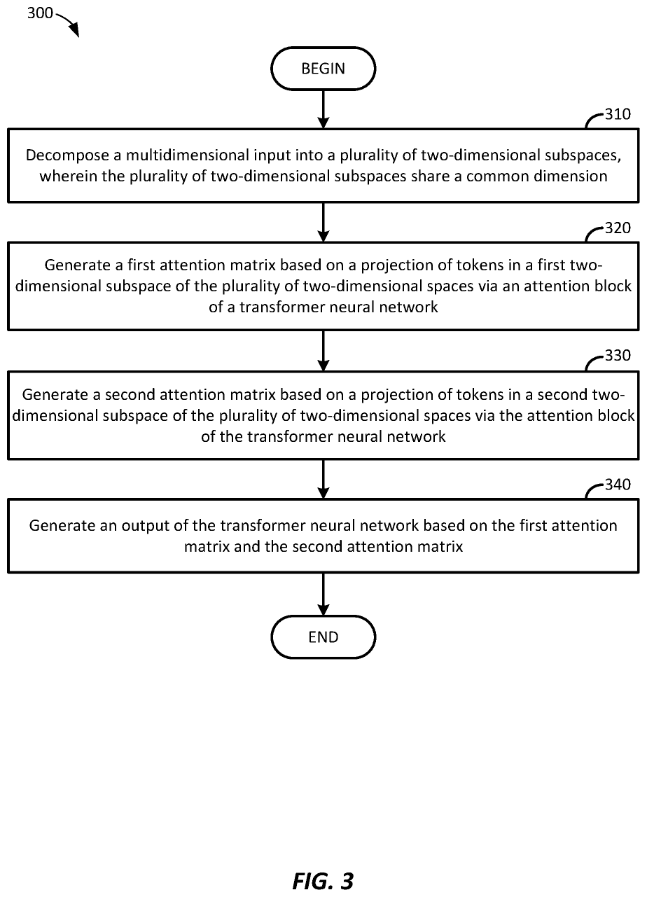

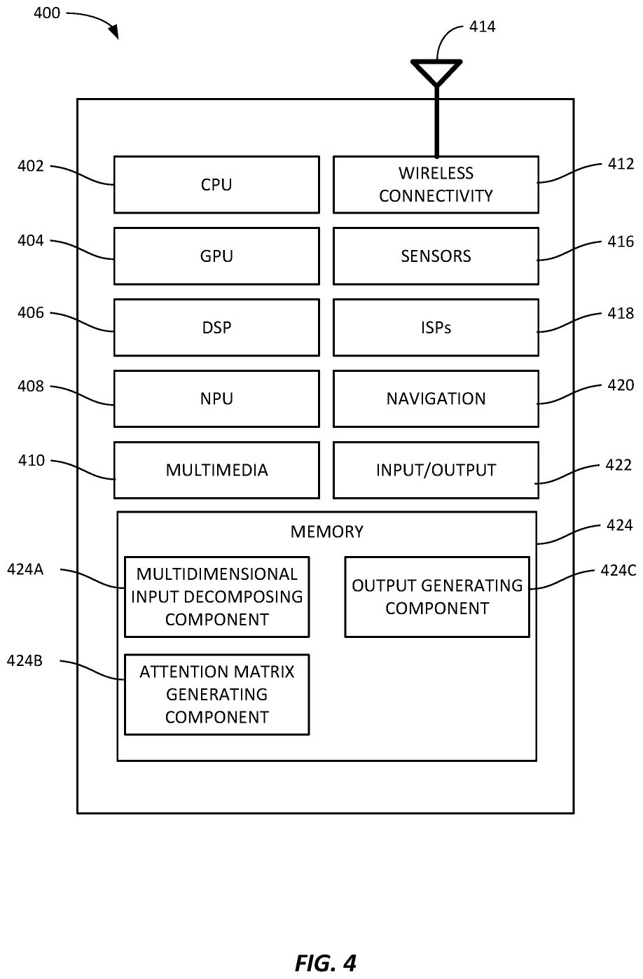

FIG. 3 illustrates example operations 300 for processing multidimensional input through a transformer neural network based on decomposition of the multidimensional input into two-dimensional subspaces, according to aspects of the present disclosure. Operations 300 may be performed, for example, by a computing system on which a transformer neural network is deployed for processing multidimensional data, such as a user equipment (UE), a smartphone, a tablet computer, an autonomous vehicle, an edge device, or other computing system (e.g., such as processing system 400 illustrated in FIG. 4 and described in further detail below).

As illustrated, operations 300 begin at block 310 with decomposing a multidimensional input into a plurality of two-dimensional subspaces. The plurality of two-dimensional subspaces share a common dimension. Because the two-dimensional subspaces generally share a common dimension, the number of two-dimensional subspaces into which an n-dimensional input may be decomposed may be n−1. For example, a three-dimensional space in which an input lies may be decomposed into two, two-dimensional subspaces.

In some aspects, the multidimensional input may include an input having a plurality of spatial dimensions and a time dimension. For example, the multidimensional input may be a video clip including a plurality of frames (the time dimension) including two-dimensional spatial data (e.g., height and width). In such a case, the first two-dimensional subspace may be a subspace based on a first spatial dimension of the plurality of spatial dimensions and the time dimension, and the second two-dimensional subspace may be a subspace based on a second spatial dimension of the plurality of spatial dimensions and the time dimension.

At block 320, operations 300 proceed with generating a first attention matrix based on a projection of tokens in a first two-dimensional subspace of the plurality of two-dimensional subspaces via an attention block of a transformer neural network.

In some aspects, generating the first attention matrix based on the projection of tokens in the first two-dimensional subspace comprises projecting the first two-dimensional subspace into query, key, and value data. The first attention matrix may be generated based on the query data, the key data, and a number of temporal components in the first two-dimensional subspace.

At block 330, operations 300 proceed with generating a second attention matrix based on a projection of tokens in a second two-dimensional subspace of the plurality of two-dimensional subspaces via the attention block of the transformer neural network.

In some aspects, generating the second attention matrix based on the projection of tokens in the second two-dimensional subspace comprises projecting the second two-dimensional subspace into query, key, and value data. The second attention matrix may be generated based on the query data, the key data, and a number of temporal components in the second two-dimensional subspace.

At block 340, operations 300 proceed with generating an output of the transformer neural network based on the first attention matrix and the second attention matrix (e.g., a combination of the first attention matrix and the second attention matrix). The combination may be a sum, for example.

In some aspects, generating the output of the transformer neural network includes computing a first feature based on the first attention matrix and values projected from the tokens in the first two-dimensional subspace. A second feature may be computed based on the second attention matrix and values projected from the tokens in the second two-dimensional subspace. The first feature and the second feature may be combined into a combined feature representing the multidimensional input, and the output of the transformer neural network may be generated based on the combined feature.

In some aspects, generating the output of the transformer neural network based on the combined feature comprises generating the output by processing the combined feature through a feed-forward component of the transformer neural network.

In some aspects, operations 300 further include taking one or more actions based on the generated output of the transformer neural network. The generated output of the transformer neural network may include, for example, an identification of different portions of a multidimensional input corresponding to different objects or classes of objects and, for each object or class of object, information identifying an importance of such an object to a scene. The one or more actions may include taking actions with respect to one or more of the objects in the scene based, at least in part, on the importance of such an object to the scene. For example, varying levels of compression may be applied to different portions of the multidimensional input, with higher levels of compression (with increased compression loss) being applied to less important portions of the multidimensional input and lower levels of compression (with lower or no compression loss) being applied to more important portions of the multidimensional input. In another example, the generated output of the transformer neural network may include an identification of objects in the multidimensional space and a prediction of how at least some of the identified objects will move through the multidimensional space. The one or more actions may include generating one or more control inputs to manage the movement of an autonomous or semi-autonomous device through the multidimensional space. The autonomous or semi-autonomous device may include, for example, an autonomous vehicle, a robotic arm, or other devices that can move within a multidimensional space with limited or no human control. Of course, it should be recognized that these outputs and actions performed based on the outputs described above are illustrative, and the outputs and actions performed based on the outputs generated by a transformer neural network may vary based on the environment from which the multidimensional input is captured and the environment in which a device that processes and/or uses the multidimensional input operates.

### Example Processing System for Processing Multidimensional Inputs in Transformer Neural Networks Based on Subspace Decomposition of Multidimensional Inputs

FIG. 4 depicts an example processing system 400 configured to perform various aspects of the present disclosure, including, for example, the techniques and methods described with respect to FIGS. 1-3. In one aspect, the processing system 400 may train, implement, or provide a machine learning model using transformer-based architectures, such as the architecture 100 of FIG. 1. Although depicted as a single system for conceptual clarity, in at least some aspects, as discussed above, the operations described below with respect to the processing system 400 may be distributed across any number of devices.

Processing system 400 includes a central processing unit (CPU) 402, which in some examples may be a multi-core CPU. Instructions executed at the CPU 402 may be loaded, for example, from a program memory associated with the CPU 402 or may be loaded from a partition of memory 424.

Processing system 400 also includes additional processing components tailored to specific functions, such as a graphics processing unit (GPU) 404, a digital signal processor (DSP) 406, a neural processing unit (NPU) 408, a multimedia processing unit 410, and a wireless connectivity component 412.

An NPU, such as NPU 408, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as NPU 408, are configured to accelerate the performance of common machine learning tasks, such as image classification, machine translation, object detection, and various other predictive models. In some examples, a plurality of NPUs may be instantiated on a single chip, such as a system-on-a-chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In one implementation, NPU 408 is a part of one or more of CPU 402, GPU 404, and/or DSP 406.

In some examples, wireless connectivity component 412 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless transmission standards. Wireless connectivity component 412 is further connected to one or more antennas 414.

Processing system 400 may also include one or more sensor processing units 416 associated with any manner of sensor, one or more image signal processors (ISPs) 418 associated with any manner of image sensor, and/or a navigation component 420, which may include satellite-based positioning system components (e.g., GPS or GLONASS) as well as inertial positioning system components.

Processing system 400 may also include one or more input and/or output devices 422, such as screens, touch-sensitive surfaces (including touch-sensitive displays), physical buttons, speakers, microphones, and the like.

In some examples, one or more of the processors of processing system 400 may be based on an ARM or RISC-V instruction set.

Processing system 400 also includes memory 424, which is representative of one or more static and/or dynamic memories, such as a dynamic random access memory, a flash-based static memory, and the like. In this example, memory 424 includes computer-executable components, which may be executed by one or more of the aforementioned processors of processing system 400.

In particular, in this example, memory 424 includes a multidimensional input decomposing component 424A, an attention matrix generating component 424B, and an output generating component 424C. Though depicted as discrete components for conceptual clarity in FIG. 4, the illustrated components (and others not depicted) may be collectively or individually implemented in various aspects.

Generally, processing system 400 and/or components thereof may be configured to perform the methods described herein.

Notably, in other aspects, aspects of processing system 400 may be omitted, such as where processing system 400 is a server computer or the like. For example, multimedia processing unit 410, wireless connectivity component 412, sensor processing units 416, ISPs 418, and/or navigation component 420 may be omitted in other aspects. Further, aspects of processing system 400 maybe distributed between multiple devices.

### Example Clauses

Implementation details of various aspects of the present disclosure are described in the following numbered clauses:

Clause 1: A processor-implemented method, comprising: decomposing a multidimensional input into a plurality of two-dimensional subspaces, wherein the plurality of two-dimensional subspaces share a common dimension; generating a first attention matrix based on a projection of tokens in a first two-dimensional subspace of the plurality of two-dimensional subspaces via an attention block of a transformer neural network; generating a second attention matrix based on a projection of tokens in a second two-dimensional subspace of the plurality of two-dimensional subspaces via the attention block of the transformer neural network; and generating an output of the transformer neural network based on the first attention matrix and the second attention matrix.

Clause 2: The method of Clause 1, wherein the multidimensional input comprises an input having a plurality of spatial dimensions and a time dimension.

Clause 3: The method of Clause 2, wherein the plurality of spatial dimensions comprises a width spatial dimension and a height spatial dimension and wherein the common dimension comprises the time dimension, such that computational complexity involved in generating the output of the transformer neural network is reduced relative to decomposing the multidimensional input into a spatial component and a time component.

Clause 4: The method of Clause 2 or 3, wherein the multidimensional input comprises a video input.

Clause 5: The method of any of Clauses 2 through 4, wherein: the first two-dimensional subspace comprises a subspace based on a first spatial dimension of the plurality of spatial dimensions and the time dimension, and the second two-dimensional subspace comprises a subspace based on a second spatial dimension of the plurality of spatial dimensions and the time dimension.

Clause 6: The method of any of Clauses 1 through 5, wherein generating the output of the transformer neural network comprises: computing a first feature based on the first attention matrix and values projected from the tokens in the first two-dimensional subspace; computing a second feature based on the second attention matrix and values projected from the tokens in the second two-dimensional subspace; combining the first feature and the second feature into a combined feature representing the multidimensional input; and generating the output of the transformer neural network based on the combined feature.

Clause 7: The method of Clause 6, wherein the combined feature comprises a sum of the first feature and the second feature.

Clause 8: The method of Clause 6 or 7, wherein generating the output of the transformer neural network based on the combined feature comprises generating the output by processing the combined feature through a feed-forward component of the transformer neural network.

Clause 9: The method of any of Clauses 1 through 8, wherein generating the first attention matrix based on the projection of the tokens in the first two-dimensional subspace comprises: projecting the first two-dimensional subspace into query data, key data, and value data; and generating the first attention matrix based on the query data, the key data, and a number of components from the common dimension in the first two-dimensional subspace.

Clause 10: The method of any of Clauses 1 through 9, wherein generating the second attention matrix based on the projection of the tokens in the second two-dimensional subspace comprises: projecting the second two-dimensional subspace into query data, key data, and value data; and generating the second attention matrix based on the query data, the key data, and a number of components from the common dimension in the second two-dimensional subspace.

Clause 11: A processing system comprising: a memory comprising computer-executable instructions; and one or more processors configured to execute the computer-executable instructions and cause the processing system to perform a method in accordance with any of Clauses 1-10.

Clause 12: A processing system comprising means for performing a method in accordance with any of Clauses 1-10.

Clause 13: A non-transitory computer-readable medium comprising computer-executable instructions that, when executed by one or more processors of a processing system, cause the processing system to perform a method in accordance with any of Clauses 1-10.

Clause 14: A computer program product embodied on a computer-readable storage medium comprising code for performing a method in accordance with any of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
decomposing a multidimensional input into a plurality of two-dimensional subspaces, wherein the plurality of two-dimensional subspaces share a common dimension;
generating a first attention matrix based on a projection of tokens in a first two-dimensional subspace of the plurality of two-dimensional subspaces via an attention block of a transformer neural network;
generating a second attention matrix based on a projection of tokens in a second two-dimensional subspace of the plurality of two-dimensional subspaces via the attention block of the transformer neural network; and
generating an output of the transformer neural network based on the first attention matrix and the second attention matrix.

2. The method of claim 1, wherein the multidimensional input comprises an input having a plurality of spatial dimensions and a time dimension.

3. The method of claim 2, wherein the plurality of spatial dimensions comprises a width spatial dimension and a height spatial dimension and wherein the common dimension comprises the time dimension, such that computational complexity involved in generating the output of the transformer neural network is reduced relative to decomposing the multidimensional input into a spatial component and a time component.

4. The method of claim 2, wherein the multidimensional input comprises a video input.

5. The method of claim 2, wherein:
the first two-dimensional subspace comprises a subspace based on a first spatial dimension of the plurality of spatial dimensions and the time dimension, and
the second two-dimensional subspace comprises a subspace based on a second spatial dimension of the plurality of spatial dimensions and the time dimension.

6. The method of claim 1, wherein generating the output of the transformer neural network comprises:
computing a first feature based on the first attention matrix and values projected from the tokens in the first two-dimensional subspace;
computing a second feature based on the second attention matrix and values projected from the tokens in the second two-dimensional subspace;
combining the first feature and the second feature into a combined feature representing the multidimensional input; and
generating the output of the transformer neural network based on the combined feature.

7. The method of claim 6, wherein the combined feature comprises a sum of the first feature and the second feature.

8. The method of claim 6, wherein generating the output of the transformer neural network based on the combined feature comprises processing the combined feature through a feed-forward component of the transformer neural network.

9. The method of claim 1, wherein generating the first attention matrix based on the projection of the tokens in the first two-dimensional subspace comprises:
projecting the first two-dimensional subspace into query data, key data, and value data; and
generating the first attention matrix based on the query data, the key data, and a number of components from the common dimension in the first two-dimensional subspace.

10. The method of claim 1, wherein generating the second attention matrix based on the projection of the tokens in the second two-dimensional subspace comprises:
projecting the second two-dimensional subspace into query data, key data, and value data; and
generating the second attention matrix based on the query data, the key data, and a number of components from the common dimension in the second two-dimensional subspace.

11. A system, comprising:
a memory having executable instructions stored thereon; and
a processor configured to execute the executable instructions in order to cause the system to:
decompose a multidimensional input into a plurality of two-dimensional subspaces, wherein the plurality of two-dimensional subspaces share a common dimension;
generate a first attention matrix based on a projection of tokens in a first two-dimensional subspace of the plurality of two-dimensional subspaces via an attention block of a transformer neural network;
generate a second attention matrix based on a projection of tokens in a second two-dimensional subspace of the plurality of two-dimensional subspaces via the attention block of the transformer neural network; and
generate an output of the transformer neural network based on the first attention matrix and the second attention matrix.

12. The system of claim 11, wherein the multidimensional input comprises an input having a plurality of spatial dimensions and a time dimension.

13. The system of claim 12, wherein the plurality of spatial dimensions comprises a width spatial dimension and a height spatial dimension and wherein the common dimension comprises the time dimension, such that computational complexity involved in generating the output of the transformer neural network is reduced relative to decomposing the multidimensional input into a spatial component and a time component.

14. The system of claim 12, wherein the multidimensional input comprises a video input.

15. The system of claim 12, wherein:
the first two-dimensional subspace comprises a subspace based on a first spatial dimension of the plurality of spatial dimensions and the time dimension, and
the second two-dimensional subspace comprises a subspace based on a second spatial dimension of the plurality of spatial dimensions and the time dimension.

16. The system of claim 11, wherein in order to generate the output of the transformer neural network, the processor is configured to cause the system to:
compute a first feature based on the first attention matrix and values projected from the tokens in the first two-dimensional subspace;
compute a second feature based on the second attention matrix and values projected from the tokens in the second two-dimensional subspace;
combine the first feature and the second feature into a combined feature representing the multidimensional input; and
generate the output of the transformer neural network based on the combined feature.

17. The system of claim 16, wherein in order to generate the output of the transformer neural network based on the combined feature, the processor is configured to cause the system to process the combined feature through a feed-forward component of the transformer neural network.

18. The system of claim 11, wherein in order to generate the first attention matrix based on the projection of the tokens in the first two-dimensional subspace, the processor is configured to cause the system to:
project the first two-dimensional subspace into query data, key data, and value data; and
generate the first attention matrix based on the query data, the key data, and a number of components from the common dimension in the first two-dimensional subspace.

19. The system of claim 11, wherein in order to generate the second attention matrix based on the projection of the tokens in the second two-dimensional subspace, the processor is configured to cause the system to:
project the second two-dimensional subspace into query data, key data, and value data; and
generate the second attention matrix based on the query data, the key data, and a number of components from the common dimension in the second two-dimensional subspace.

20. A system, comprising:
means for decomposing a multidimensional input into a plurality of two-dimensional subspaces, wherein the plurality of two-dimensional subspaces share a common dimension;
means for generating a first attention matrix based on a projection of tokens in a first two-dimensional subspace of the plurality of two-dimensional subspaces via an attention block of a transformer neural network;
means for generating a second attention matrix based on a projection of tokens in a second two-dimensional subspace of the plurality of two-dimensional subspaces via the attention block of the transformer neural network; and
means for generating an output of the transformer neural network based on the first attention matrix and the second attention matrix.

21. The system of claim 20, wherein the multidimensional input comprises an input having a plurality of spatial dimensions and a time dimension.

22. The system of claim 21, wherein the plurality of spatial dimensions comprises a width spatial dimension and a height spatial dimension and wherein the common dimension comprises the time dimension, such that computational complexity involved in generating the output of the transformer neural network is reduced relative to decomposing the multidimensional input into a spatial component and a time component.

23. The system of claim 21, wherein:
the first two-dimensional subspace comprises a subspace based on a first spatial dimension of the plurality of spatial dimensions and the time dimension, and
the second two-dimensional subspace comprises a subspace based on a second spatial dimension of the plurality of spatial dimensions and the time dimension.

24. The system of claim 20, wherein the means for generating the output of the transformer neural network comprises:
means for computing a first feature based on the first attention matrix and values projected from the tokens in the first two-dimensional subspace;
means for computing a second feature based on the second attention matrix and values projected from the tokens in the second two-dimensional subspace;
means for combining the first feature and the second feature into a combined feature representing the multidimensional input; and
means for generating the output of the transformer neural network based on the combined feature.

25. The system of claim 24, wherein the means for generating the output of the transformer neural network based on the combined feature comprises means for processing the combined feature through a feed-forward component of the transformer neural network.

26. The system of claim 20, wherein the means for generating the first attention matrix based on the projection of the tokens in the first two-dimensional subspace comprises:
means for projecting the first two-dimensional subspace into query data, key data, and value data; and
means for generating the first attention matrix based on the query data, the key data, and a number of components from the common dimension in the first two-dimensional subspace.

27. The system of claim 20, wherein the means for generating the second attention matrix based on the projection of the tokens in the second two-dimensional subspace comprises:
means for projecting the second two-dimensional subspace into query data, key data, and value data; and
means for generating the second attention matrix based on the query data, the key data, and a number of components from the common dimension in the second two-dimensional subspace.

28. A computer-readable medium having executable instructions stored thereon which, when executed by a processor, perform an operation comprising:
decomposing a multidimensional input into a plurality of two-dimensional subspaces, wherein the plurality of two-dimensional subspaces share a common dimension;
generating a first attention matrix based on a projection of tokens in a first two-dimensional subspace of the plurality of two-dimensional subspaces via an attention block of a transformer neural network;
generating a second attention matrix based on a projection of tokens in a second two-dimensional subspace of the plurality of two-dimensional subspaces via the attention block of the transformer neural network; and
generating an output of the transformer neural network based on the first attention matrix and the second attention matrix.

29. The computer-readable medium of claim 28, wherein the multidimensional input comprises an input having a plurality of spatial dimensions and a time dimension.

30. The computer-readable medium of claim 29, wherein the plurality of spatial dimensions comprises a width spatial dimension and a height spatial dimension and wherein the common dimension comprises the time dimension, such that computational complexity involved in generating the output of the transformer neural network is reduced relative to decomposing the multidimensional input into a spatial component and a time component.

31. The computer-readable medium of claim 29, wherein:
the first two-dimensional subspace comprises a subspace based on a first spatial dimension of the plurality of spatial dimensions and the time dimension, and
the second two-dimensional subspace comprises a subspace based on a second spatial dimension of the plurality of spatial dimensions and the time dimension.

32. The computer-readable medium of claim 28, wherein generating the output of the transformer neural network comprises:
computing a first feature based on the first attention matrix and values projected from the tokens in the first two-dimensional subspace;
computing a second feature based on the second attention matrix and values projected from the tokens in the second two-dimensional subspace;
combining the first feature and the second feature into a combined feature representing the multidimensional input; and
generating the output of the transformer neural network based on the combined feature.

33. The computer-readable medium of claim 32, wherein generating the output of the transformer neural network based on the combined feature comprises processing the combined feature through a feed-forward component of the transformer neural network.

34. The computer-readable medium of claim 28, wherein generating the first attention matrix based on the projection of the tokens in the first two-dimensional subspace comprises:
projecting the first two-dimensional subspace into query data, key data, and value data; and
generating the first attention matrix based on the query data, the key data, and a number of components from the common dimension in the first two-dimensional subspace.

35. The computer-readable medium of claim 28, wherein generating the second attention matrix based on the projection of the tokens in the second two-dimensional subspace comprises:
projecting the second two-dimensional subspace into query data, key data, and value data; and
generating the second attention matrix based on the query data, the key data, and a number of components from the common dimension in the second two-dimensional subspace.
